(19) United States
(12) Patent Application Publication
(10) Pub. No.: US 2024/0031087 A1
(43) Pub. Date: Jan. 25, 2024

(54) APPARATUS, SYSTEM, AND METHOD OF 40 MEGAHERTZ OPERATING NON ACCESS POINT (NON-AP) STATION

(71) Applicants: Juan Fang, Portland, OR (US); Po-Kai Huang, San Jose, CA (US); Danny Alexander, Monoson (IL); Shlomi Vituri, Tel Aviv (IL); Qinghua Li, San Ramon, CA (US)

(72) Inventors: Juan Fang, Portland, OR (US); Po-Kai Huang, San Jose, CA (US); Danny Alexander, Monoson (IL); Shlomi Vituri, Tel Aviv (IL); Qinghua Li, San Ramon, CA (US)

(21) Appl. No.: 18/479,009

(22) Filed: Sep. 30, 2023

(51) Int. Cl. H04L 5/00; H04W 72/0453

(52) U.S. Cl. CPC H04L 5/0039; H04W 72/0453; H04L 5/0007

(57) ABSTRACT

For example, a non Access Point (AP) (non-AP) station (STA) may be configured to operate in a 40 Megahertz (MHz) operating mode, as a 40 MHz operating non-AP STA, which supports a 40 MHz operating channel width. For example, the 40 MHz operating non-AP STA may be capable to process allocation information from an AP to identify a Resource Unit (RU) or Multiple RU (MRU) (RU/MRU) allocated to the 40 MHz operating non-AP STA within the 40 MHz operating channel width; and to communicate data over the RU/MRU allocated to the 40 MHz operating non-AP STA as part of a wider bandwidth Orthogonal Frequency Division Multiple Access (OFDMA) transmission over a channel bandwidth of at least 80 MHz.

### BACKGROUND

A wireless communication station (STA) may be configured to communicate with an Access Point (AP) over a wireless communication channel.

In some wireless communication systems, the STA may be configured to communicate one or more downlink (DL) communications from the AP to the STA, and/or one or more uplink (UL) communications from the STA to the AP, for example, according to an Orthogonal Frequency Division Multiple Access (OFDMA) scheme.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic flow-chart illustration of a method of a 40 Megahertz (MHz) operating non Access Point (non-AP) station (STA), in accordance with some demonstrative aspects.

FIG. 3 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects may be used in conjunction with various devices and systems, for example, a User Equipment (UE), a Mobile Device (MD), a wireless station (STA), a Personal Computer (PC), a desktop computer, a mobile computer, a laptop computer, a notebook computer, a tablet computer, a server computer, a handheld computer, a handheld device, a wearable device, a sensor device, an Internet of Things (IoT) device, a Personal Digital Assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless Access Point (AP), a wired or wireless router, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), and the like.

Some aspects may be used in conjunction with devices and/or networks operating in accordance with existing IEEE 802.11 standards (including IEEE 802.11-2020 (IEEE 802.11-2020, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications, December, 2020); IEEE 802.11ax (IEEE 802.11ax-2021, IEEE Standard for Information Technology—Telecommunications and Information Exchange between Systems Local and Metropolitan Area Networks—Specific Requirements; Part 11: Wireless LAN Medium Access Control (MAC) and Physical Layer (PHY) Specifications; Amendment 1: Enhancements for High-Efficiency WLAN, February 2021); and/or IEEE 802.11be (IEEE P802.11be/D4.0 Draft Standard for Information technology—Telecommunications and information exchange between systems Local and metropolitan area networks—Specific requirements; Part 11: Wireless LAN Medium Access Control (MAC) and Physical Layer (PHY) Specifications; Amendment 8: Enhancements for extremely high throughput (EHT), July 2023)) and/or future versions and/or derivatives thereof, devices and/or networks operating in accordance with existing cellular specifications and/or protocols, and/or future versions and/or derivatives thereof, units and/or devices which are part of the above networks, and the like.

Some aspects may be used in conjunction with one way and/or two-way radio communication systems, cellular radio-telephone communication systems, a mobile phone, a cellular telephone, a wireless telephone, a Personal Communication Systems (PCS) device, a PDA device which incorporates a wireless communication device, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some aspects may be used in conjunction with one or more types of wireless communication signals and/or systems, for example, Radio Frequency (RF), Infra-Red (IR), Frequency-Division Multiplexing (FDM), Orthogonal FDM (OFDM), Orthogonal Frequency-Division Multiple Access (OFDMA), FDM Time-Division Multiplexing (TDM), Time-Division Multiple Access (TDMA), Multi-User MIMO (MU-MIMO), Spatial Division Multiple Access (SDMA), Extended TDMA (E-TDMA), General Packet Radio Service (GPRS), extended GPRS, Code-Division Multiple Access (CDMA), Wideband CDMA (WCDMA), CDMA 2000, single-carrier CDMA, multi-carrier CDMA, Multi-Carrier Modulation (MDM), Discrete Multi-Tone (DMT), Bluetooth®, Global Positioning System (GPS), Wi-Fi, Wi-Max, ZigBee™ Ultra-Wideband (UWB), 4G, Fifth Generation (5G), or Sixth Generation (6G) mobile networks, 3GPP, Long Term Evolution (LTE), LTE advanced, Enhanced Data rates for GSM Evolution (EDGE), or the like. Other aspects may be used in various other devices, systems and/or networks.

The term “wireless device”, as used herein, includes, for example, a device capable of wireless communication, a communication device capable of wireless communication, a communication station capable of wireless communication, a portable or non-portable device capable of wireless communication, or the like. In some demonstrative aspects, a wireless device may be or may include a peripheral that may be integrated with a computer, or a peripheral that may be attached to a computer. In some demonstrative aspects, the term “wireless device” may optionally include a wireless service.

The term “communicating” as used herein with respect to a communication signal includes transmitting the communication signal and/or receiving the communication signal. For example, a communication unit, which is capable of communicating a communication signal, may include a transmitter to transmit the communication signal to at least one other communication unit, and/or a communication receiver to receive the communication signal from at least one other communication unit. The verb communicating may be used to refer to the action of transmitting or the action of receiving. In one example, the phrase “communicating a signal” may refer to the action of transmitting the signal by a first device, and may not necessarily include the action of receiving the signal by a second device. In another example, the phrase “communicating a signal” may refer to the action of receiving the signal by a first device, and may not necessarily include the action of transmitting the signal by a second device. The communication signal may be transmitted and/or received, for example, in the form of Radio Frequency (RF) communication signals, and/or any other type of signal.

As used herein, the term “circuitry” may refer to, be part of, or include, an Application Specific Integrated Circuit (ASIC), an integrated circuit, an electronic circuit, a processor (shared, dedicated or group), and/or memory (shared. Dedicated, or group), that execute one or more software or firmware programs, a combinational logic circuit, and/or other suitable hardware components that provide the described functionality. In some aspects, some functions associated with the circuitry may be implemented by, one or more software or firmware modules. In some aspects, circuitry may include logic, at least partially operable in hardware.

The term “logic” may refer, for example, to computing logic embedded in circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in, and/or implemented as part of, various circuitry, e.g. radio circuitry, receiver circuitry, control circuitry, transmitter circuitry, transceiver circuitry, processor circuitry, and/or the like. In one example, logic may be embedded in volatile memory and/or non-volatile memory, including random access memory, read only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

Some demonstrative aspects may be used in conjunction with a WLAN, e.g., a WiFi network. Other aspects may be used in conjunction with any other suitable wireless communication network, for example, a wireless area network, a “piconet”, a WPAN, a WVAN and the like.

Some demonstrative aspects may be used in conjunction with a wireless communication network communicating over a sub-10 Gigahertz (GHz) frequency band, for example, a 2.4 GHz frequency band, a 5 GHz frequency band, a 6 GHz frequency band, and/or any other frequency band below 10 GHz.

Some demonstrative aspects may be used in conjunction with a wireless communication network communicating over an Extremely High Frequency (EHF) band (also referred to as the “millimeter wave (mmWave)” frequency band), for example, a frequency band within the frequency band of between 20 Ghz and 300 GHz, for example, a frequency band above 45 GHz, e.g., a 60 GHz frequency band, and/or any other mmWave frequency band. Some demonstrative aspects may be used in conjunction with a wireless communication network communicating over the sub-10 GHz frequency band and/or the mmWave frequency band, e.g., as described below. However, other aspects may be implemented utilizing any other suitable wireless communication frequency bands, for example, a 5G frequency band, a frequency band below 20 GHz, a Sub 1 GHz (S1G) band, a WLAN frequency band, a WPAN frequency band, and the like.

Some demonstrative aspects may be implemented by an mmWave STA (mSTA), which may include for example, a STA having a radio transmitter, which is capable of operating on a channel that is within the mmWave frequency band. In one example, mmWave communications may involve one or more directional links to communicate at a rate of multiple gigabits per second, for example, at least 1 Gigabit per second, e.g., at least 7 Gigabit per second, at least 30 Gigabit per second, or any other rate.

In some demonstrative aspects, the mmWave STA may include a Directional Multi-Gigabit (DMG) STA, which may be configured to communicate over a DMG frequency band. For example, the DMG band may include a frequency band wherein the channel starting frequency is above 45 GHz.

In some demonstrative aspects, the mmWave STA may include an Enhanced DMG (EDMG) STA, which may be configured to implement one or more mechanisms, which may be configured to enable Single User (SU) and/or Multi-User (MU) communication of Downlink (DL) and/or Uplink frames (UL) using a MIMO scheme. For example, the EDMG STA may be configured to implement one or more channel bonding mechanisms, which may, for example, support communication over a channel bandwidth (BW) (also referred to as a “wide channel”, an “EDMG channel”, or a “bonded channel”) including two or more channels, e.g., two or more 2.16 GHz channels. For example, the channel bonding mechanisms may include, for example, a mechanism and/or an operation whereby two or more channels, e.g., 2.16 GHz channels, can be combined, e.g., for a higher bandwidth of packet transmission, for example, to enable achieving higher data rates, e.g., when compared to transmissions over a single channel. Some demonstrative aspects are described herein with respect to communication over a channel BW including two or more 2.16 GHz channels, however other aspects may be implemented with respect to communications over a channel bandwidth, e.g., a “wide” channel, including or formed by any other number of two or more channels, for example, an aggregated channel including an aggregation of two or more channels. For example, the EDMG STA may be configured to implement one or more channel bonding mechanisms, which may, for example, support an increased channel bandwidth, for example, a channel BW of 4.32 GHz, a channel BW of 6.48 GHz, a channel BW of 8.64 GHz, and/or any other additional or alternative channel BW. The EDMG STA may perform other additional or alternative functionality.

In other aspects, the mmWave STA may include any other type of STA and/or may perform other additional or alternative functionality. Other aspects may be implemented by any other apparatus, device and/or station.

The term “antenna”, as used herein, may include any suitable configuration, structure and/or arrangement of one or more antenna elements, components, units, assemblies and/or arrays. In some aspects, the antenna may implement transmit and receive functionalities using separate transmit and receive antenna elements. In some aspects, the antenna may implement transmit and receive functionalities using common and/or integrated transmit/receive elements. The antenna may include, for example, a phased array antenna, a single element antenna, a set of switched beam antennas, and/or the like.

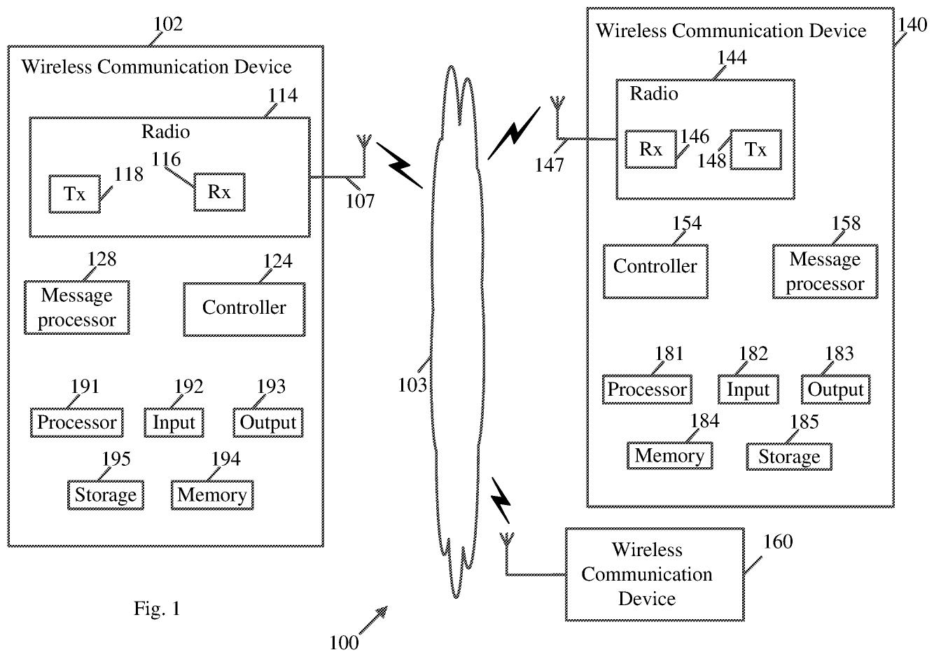

Reference is made to FIG. 1, which schematically illustrates a system 100, in accordance with some demonstrative aspects.

As shown in FIG. 1, in some demonstrative aspects, system 100 may include one or more wireless communication devices. For example, system 100 may include a wireless communication device 102, a wireless communication device 140, a wireless communication device 160, and/or one more other devices.

In some demonstrative aspects, devices 102, 140, and/or 160 may include a mobile device or a non-mobile, e.g., a static, device.

For example, devices 102, 140, and/or 160 may include, for example, a UE, an MD, a STA, an AP, a PC, a desktop computer, a mobile computer, a laptop computer, an Ultrabook™ computer, a notebook computer, a tablet computer, a server computer, a handheld computer, an Internet of Things (IoT) device, a sensor device, a handheld device, a wearable device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “Carry Small Live Large” (CSLL) device, an Ultra Mobile Device (UMD), an Ultra Mobile PC (UMPC), a Mobile Internet Device (MID), an “Origami” device or computing device, a device that supports Dynamically Composable Computing (DCC), a context-aware device, a video device, an audio device, an A/V device, a Set-Top-Box (STB), a Blu-ray disc (BD) player, a BD recorder, a Digital Video Disc (DVD) player, a High Definition (HD) DVD player, a DVD recorder, a HD DVD recorder, a Personal Video Recorder (PVR), a broadcast HD receiver, a video source, an audio source, a video sink, an audio sink, a stereo tuner, a broadcast radio receiver, a flat panel display, a Personal Media Player (PMP), a digital video camera (DVC), a digital audio player, a speaker, an audio receiver, an audio amplifier, a gaming device, a data source, a data sink, a Digital Still camera (DSC), a media player, a Smartphone, a television, a music player or the like.

In some demonstrative aspects, device 102 may include, for example, one or more of a processor 191, an input unit 192, an output unit 193, a memory unit 194, and/or a storage unit 195; and/or device 140 may include, for example, one or more of a processor 181, an input unit 182, an output unit 183, a memory unit 184, and/or a storage unit 185. Devices 102 and/or 140 may optionally include other suitable hardware components and/or software components. In some demonstrative aspects, some or all of the components of one or more of devices 102 and/or 140 may be enclosed in a common housing or packaging, and may be interconnected or operably associated using one or more wired or wireless links. In other aspects, components of one or more of devices 102 and/or 140 may be distributed among multiple or separate devices.

In some demonstrative aspects, processor 191 and/or processor 181 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications. Processor 181 may execute instructions, for example, of an Operating System (OS) of device 140 and/or of one or more suitable applications.

In some demonstrative aspects, input unit 192 and/or input unit 182 may include, for example, a keyboard, a keypad, a mouse, a touch-screen, a touch-pad, a track-ball, a stylus, a microphone, or other suitable pointing device or input device. Output unit 193 and/or output unit 183 may include, for example, a monitor, a screen, a touch-screen, a flat panel display, a Light Emitting Diode (LED) display unit, a Liquid Crystal Display (LCD) display unit, a plasma display unit, one or more audio speakers or earphones, or other suitable output devices.

In some demonstrative aspects, memory unit 194 and/or memory unit 184 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 and/or storage unit 185 may include, for example, a hard disk drive, a disk drive, a solid-state drive (SSD), and/or other suitable removable or non-removable storage units. Memory unit 194 and/or storage unit 195, for example, may store data processed by device 102. Memory unit 184 and/or storage unit 185, for example, may store data processed by device 140.

In some demonstrative aspects, wireless communication devices 102, 140, and/or 160 may be capable of communicating content, data, information and/or signals via a wireless medium (WM) 103. In some demonstrative aspects, wireless medium 103 may include, for example, a radio channel, an RF channel, a WiFi channel, a cellular channel, a 5G channel, an IR channel, a Bluetooth (BT) channel, a Global Navigation Satellite System (GNSS) Channel, and the like.

In some demonstrative aspects, WM 103 may include one or more wireless communication frequency bands and/or channels. For example, WM 103 may include one or more channels in a sub-10 Ghz wireless communication frequency band, for example, a 2.4 GHz wireless communication frequency band, one or more channels in a 5 GHz wireless communication frequency band, and/or one or more channels in a 6 GHz wireless communication frequency band. In another example, WM 103 may additionally or alternatively include one or more channels in an mmWave wireless communication frequency band. In other aspects, WM 103 may include any other type of channel over any other frequency band.

In some demonstrative aspects, device 102, device 140, and/or device 160 may include one or more radios including circuitry and/or logic to perform wireless communication between devices 102, 140, 160, and/or one or more other wireless communication devices. For example, device 102 may include one or more radios 114, and/or device 140 may include one or more radios 144.

In some demonstrative aspects, radios 114 and/or radios 144 may include one or more wireless receivers (Rx) including circuitry and/or logic to receive wireless communication signals, RF signals, frames, blocks, transmission streams, packets, messages, data items, and/or data. For example, a radio 114 may include at least one receiver 116, and/or a radio 144 may include at least one receiver 146.

In some demonstrative aspects, radios 114 and/or 144 may include one or more wireless transmitters (Tx) including circuitry and/or logic to transmit wireless communication signals, RF signals, frames, blocks, transmission streams, packets, messages, data items, and/or data. For example, a radio 114 may include at least one transmitter 118, and/or a radio 144 may include at least one transmitter 148.

In some demonstrative aspects, radios 114 and/or 144, transmitters 118 and/or 148, and/or receivers 116 and/or 146 may include circuitry; logic; Radio Frequency (RF) elements, circuitry and/or logic; baseband elements, circuitry and/or logic; modulation elements, circuitry and/or logic; demodulation elements, circuitry and/or logic; amplifiers; analog to digital and/or digital to analog converters; filters; and/or the like. For example, radios 114 and/or 144 may include or may be implemented as part of a wireless Network Interface Card (NIC), and the like.

In some demonstrative aspects, radios 114 and/or 144 may be configured to communicate over a 2.4 GHz band, a 5 GHz band, a 6 GHz band, and/or any other band, for example, a directional band, e.g., an mmWave band, a 5G band, an S1G band, and/or any other band.

In some demonstrative aspects, radios 114 and/or 144 may include, or may be associated with one or more antennas.

In some demonstrative aspects, device 102 may include one or more antennas 107, and/or device 140 may include on or more antennas 147.

Antennas 107 and/or 147 may include any type of antennas suitable for transmitting and/or receiving wireless communication signals, blocks, frames, transmission streams, packets, messages and/or data. For example, antennas 107 and/or 147 may include any suitable configuration, structure and/or arrangement of one or more antenna elements, components, units, assemblies and/or arrays. In some aspects, antennas 107 and/or 147 may implement transmit and receive functionalities using separate transmit and receive antenna elements. In some aspects, antennas 107 and/or 147 may implement transmit and receive functionalities using common and/or integrated transmit/receive elements.

In some demonstrative aspects, device 102 may include a controller 124, and/or device 140 may include a controller 154. Controller 124 may be configured to perform and/or to trigger, cause, instruct and/or control device 102 to perform, one or more communications, to generate and/or communicate one or more messages and/or transmissions, and/or to perform one or more functionalities, operations and/or procedures between devices 102, 140, 160 and/or one or more other devices; and/or controller 154 may be configured to perform, and/or to trigger, cause, instruct and/or control device 140 to perform, one or more communications, to generate and/or communicate one or more messages and/or transmissions, and/or to perform one or more functionalities, operations and/or procedures between devices 102, 140, 160 and/or one or more other devices, e.g., as described below.

In some demonstrative aspects, controllers 124 and/or 154 may include, or may be implemented, partially or entirely, by circuitry and/or logic, e.g., one or more processors including circuitry and/or logic, memory circuitry and/or logic, Media-Access Control (MAC) circuitry and/or logic, Physical Layer (PHY) circuitry and/or logic, baseband (BB) circuitry and/or logic, a BB processor, a BB memory, Application Processor (AP) circuitry and/or logic, an AP processor, an AP memory, and/or any other circuitry and/or logic, configured to perform the functionality of controllers 124 and/or 154, respectively. Additionally or alternatively, one or more functionalities of controllers 124 and/or 154 may be implemented by logic, which may be executed by a machine and/or one or more processors, e.g., as described below.

In one example, controller 124 may include circuitry and/or logic, for example, one or more processors including circuitry and/or logic, to cause, trigger and/or control a wireless device, e.g., device 102, and/or a wireless station, e.g., a wireless STA implemented by device 102, to perform one or more operations, communications and/or functionalities, e.g., as described herein. In one example, controller 124 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In one example, controller 154 may include circuitry and/or logic, for example, one or more processors including circuitry and/or logic, to cause, trigger and/or control a wireless device, e.g., device 140, and/or a wireless station, e.g., a wireless STA implemented by device 140, to perform one or more operations, communications and/or functionalities, e.g., as described herein. In one example, controller 154 may include at least one memory, e.g., coupled to the one or more processors, which may be configured, for example, to store, e.g., at least temporarily, at least some of the information processed by the one or more processors and/or circuitry, and/or which may be configured to store logic to be utilized by the processors and/or circuitry.

In some demonstrative aspects, at least part of the functionality of controller 124 may be implemented as part of one or more elements of radio 114, and/or at least part of the functionality of controller 154 may be implemented as part of one or more elements of radio 144.

In other aspects, the functionality of controller 124 may be implemented as part of any other element of device 102, and/or the functionality of controller 154 may be implemented as part of any other element of device 140.

In some demonstrative aspects, device 102 may include a message processor 128 configured to generate, process and/or access one or messages communicated by device 102.

In one example, message processor 128 may be configured to generate one or more messages to be transmitted by device 102, and/or message processor 128 may be configured to access and/or to process one or more messages received by device 102, e.g., as described below.

In one example, message processor 128 may include at least one first component configured to generate a message, for example, in the form of a frame, field, information element and/or protocol data unit, for example, a MAC Protocol Data Unit (MPDU); at least one second component configured to convert the message into a PHY Protocol Data Unit (PPDU), for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 128 may be configured to perform any other additional or alternative functionality and/or may include any other additional or alternative components to generate and/or process a message to be transmitted.

In some demonstrative aspects, device 140 may include a message processor 158 configured to generate, process and/or access one or more messages communicated by device 140.

In one example, message processor 158 may be configured to generate one or more messages to be transmitted by device 140, and/or message processor 158 may be configured to access and/or to process one or more messages received by device 140, e.g., as described below.

In one example, message processor 158 may include at least one first component configured to generate a message, for example, in the form of a frame, field, information element and/or protocol data unit, for example, an MPDU; at least one second component configured to convert the message into a PPDU, for example, by processing the message generated by the at least one first component, e.g., by encoding the message, modulating the message and/or performing any other additional or alternative processing of the message; and/or at least one third component configured to cause transmission of the message over a wireless communication medium, e.g., over a wireless communication channel in a wireless communication frequency band, for example, by applying to one or more fields of the PPDU one or more transmit waveforms. In other aspects, message processor 158 may be configured to perform any other additional or alternative functionality and/or may include any other additional or alternative components to generate and/or process a message to be transmitted.

In some demonstrative aspects, message processors 128 and/or 158 may include, or may be implemented, partially or entirely, by circuitry and/or logic, e.g., one or more processors including circuitry and/or logic, memory circuitry and/or logic, MAC circuitry and/or logic, PHY circuitry and/or logic, BB circuitry and/or logic, a BB processor, a BB memory, AP circuitry and/or logic, an AP processor, an AP memory, and/or any other circuitry and/or logic, configured to perform the functionality of message processors 128 and/or 158, respectively. Additionally or alternatively, one or more functionalities of message processors 128 and/or 158 may be implemented by logic, which may be executed by a machine and/or one or more processors, e.g., as described below.

In some demonstrative aspects, at least part of the functionality of message processor 128 may be implemented as part of radio 114, and/or at least part of the functionality of message processor 158 may be implemented as part of radio 144.

In some demonstrative aspects, at least part of the functionality of message processor 128 may be implemented as part of controller 124, and/or at least part of the functionality of message processor 158 may be implemented as part of controller 154.

In other aspects, the functionality of message processor 128 may be implemented as part of any other element of device 102, and/or the functionality of message processor 158 may be implemented as part of any other element of device 140.

In some demonstrative aspects, at least part of the functionality of controller 124 and/or message processor 128 may be implemented by an integrated circuit, for example, a chip, e.g., a System on Chip (SoC). In one example, the chip or SoC may be configured to perform one or more functionalities of one or more radios 114. For example, the chip or SoC may include one or more elements of controller 124, one or more elements of message processor 128, and/or one or more elements of one or more radios 114. In one example, controller 124, message processor 128, and one or more radios 114 may be implemented as part of the chip or SoC.

In other aspects, controller 124, message processor 128 and/or one or more radios 114 may be implemented by one or more additional or alternative elements of device 102.

In some demonstrative aspects, at least part of the functionality of controller 154 and/or message processor 158 may be implemented by an integrated circuit, for example, a chip, e.g., a SoC. In one example, the chip or SoC may be configured to perform one or more functionalities of one or more radios 144. For example, the chip or SoC may include one or more elements of controller 154, one or more elements of message processor 158, and/or one or more elements of one or more radios 144. In one example, controller 154, message processor 158, and one or more radios 144 may be implemented as part of the chip or SoC.

In other aspects, controller 154, message processor 158 and/or one or more radios 144 may be implemented by one or more additional or alternative elements of device 140.

In some demonstrative aspects, device 102, device 140, and/or device 160 may include, operate as, perform the role of, and/or perform one or more functionalities of, one or more STAs. For example, device 102 may include at least one STA, device 140 may include at least one STA, and/or device 160 may include at least one STA.

In some demonstrative aspects, device 102, device 140, and/or device 160 may include, operate as, perform the role of, and/or perform one or more functionalities of, one or more Extremely High Throughput (EHT) STAs. For example, device 102 may include, operate as, perform the role of, and/or perform one or more functionalities of, one or more EHT STAs, and/or device 140 may include, operate as, perform the role of, and/or perform one or more functionalities of, one or more EHT STAs.

In some demonstrative aspects, for example, device 102, device 140, and/or device 160 may be configured to perform one or more operations, and/or functionalities of a WiFi 8 STA.

In other aspects, for example, device 102, device 140, and/or device 160 may be configured to perform one or more operations, and/or functionalities of an Ultra High Reliability (UHR) STA.

In other aspects, for example, device 102, device 140, and/or device 160 may be configured to perform one or more operations, and/or functionalities of any other additional or alternative type of STA.

In other aspects, device 102, device 140, and/or device 160 may include, operate as, perform the role of, and/or perform one or more functionalities of, any other wireless device and/or station, e.g., a WLAN STA, a WiFi STA, and the like.

In some demonstrative aspects, device 102, device 140, and/or device 160 may be configured operate as, perform the role of, and/or perform one or more functionalities of, an Access Point (AP), e.g., a High Throughput (HT) AP STA, a High Efficiency (HE) AP STA, an EHT AP STA, and/or a UHR AP STA.

In some demonstrative aspects, device 102, device 140, and/or device 160 may be configured to operate as, perform the role of, and/or perform one or more functionalities of, a non-AP STA, e.g., an HT non-AP STA, an HE non-AP STA, an EHT non-AP STA, and/or a UHR non-AP STA.

In other aspects, device 102, device 140, and/or device 160 may operate as, perform the role of, and/or perform one or more functionalities of, any other additional or alternative device and/or station.

In one example, a station (STA) may include a logical entity that is a singly addressable instance of a medium access control (MAC) and physical layer (PHY) interface to the wireless medium (WM). The STA may perform any other additional or alternative functionality.

In one example, an AP may include an entity that contains one station (STA) and provides access to the distribution services, via the wireless medium (WM) for associated STAs. An AP may include a STA and a distribution system access function (DSAF). The AP may perform any other additional or alternative functionality.

In some demonstrative aspects device 102, device 140, and/or device 160 may be configured to communicate in an HT network, an HE network, an EHT network, a UHR network, and/or any other network.

In some demonstrative aspects, device 102, device 140, and/or device 160 may be configured to operate in accordance with one or more Specifications, for example, including one or more IEEE 802.11 Specifications, e.g., an IEEE 802.11-2020 Specification, an IEEE 802.11ax Specification, an IEEE 802.11be Specification, and/or any other specification and/or protocol.

In some demonstrative aspects, device 102, device 140, and/or device 160 may include, operate as, perform a role of, and/or perform the functionality of, a Multi-Link Device (MLD). For example, device 102 may include, operate as, perform a role of, and/or perform the functionality of, at least one MLD, device 140 may include, operate as, perform a role of, and/or perform the functionality of, at least one MLD, and/or device 160 may include, operate as, perform a role of, and/or perform the functionality of, at least one MLD, e.g., as described below.

For example, an MLD may include a device that is a logical entity that is capable of supporting more than one affiliated station (STA) and can operate using one or more affiliated STAs. For example, the MLD may present one Medium Access Control (MAC) data service and a single MAC Service Access Point (SAP) to the Logical Link Control (LLC) sublayer. The MLD may perform any other additional or alternative functionality.

In some demonstrative aspects, for example, an infrastructure framework may include a multi-link AP logical entity, which includes APs, e.g., on one side, and a multi-link non-AP logical entity, which includes non-APs, e.g., on the other side.

In some demonstrative aspects, device 102, device 140, and/or device 160 may be configured to operate as, perform the role of, and/or perform one or more functionalities of, an AP MLD.

In some demonstrative aspects, device 102, device 140, and/or device 160 may be configured to operate as, perform the role of, and/or perform one or more functionalities of, a non-AP MLD.

In other aspects, device 102, device 140, and/or device 160 may operate as, perform the role of, and/or perform one or more functionalities of, any other additional or alternative device and/or station.

For example, an AP MLD may include an MLD, where each STA affiliated with the MLD is an AP. In one example, the AP MLD may include a multi-link logical entity, where each STA within the multi-link logical entity is an EHT AP. The AP MLD may perform any other additional or alternative functionality.

For example, a non-AP MLD may include an MLD, where each STA affiliated with the MLD is a non-AP STA. In one example, the non-AP MLD may include a multi-link logical entity, where each STA within the multi-link logical entity is a non-AP EHT STA. The non-AP MLD may perform any other additional or alternative functionality.

In some demonstrative aspects, device 102, device 140, and/or device 160 may include, operate as, perform a role of, and/or perform the functionality of, one or more AP STAs and/or one or more non-AP STAs. In one example, device 102 may include, operate as, perform a role of, and/or perform the functionality of, at least one AP STA, and/or device 140 may include, operate as, perform a role of, and/or perform the functionality of, at least one non-AP STA.

In some demonstrative aspects, device 102 may include, operate as, perform a role of, and/or perform the functionality of, a first STA, e.g., an AP STA or a non-AP STA.

In some demonstrative aspects, device 140 may include, operate as, perform a role of, and/or perform the functionality of, a second STA, e.g., an AP STA or a non-AP STA.

In some demonstrative aspects, device 160 may include, operate as, perform a role of, and/or perform the functionality of, a third STA, e.g., an AP STA or a non-AP STA.

In other aspects, device 102, device 140, and/or device 160 may include, operate as, perform a role of, and/or perform the functionality of any other additional or alternative type of STA.

In some demonstrative aspects, device 102, device 140, and/or device 160 may be configured to implement one or more operations and/or functionalities of a reduced bandwidth communication mechanism, which may be configured to support narrow-band operation of a non-AP STA, e.g., as described below.

In some demonstrative aspects, the reduced bandwidth communication mechanism may be configured to support narrow-band operation of the non-AP STA, for example, in a narrow channel width, which may be narrower than a channel width of an AP, e.g., as described below.

In some demonstrative aspects, the reduced bandwidth communication mechanism may be configured to support narrow-band operation of the non-AP STA, for example, in a narrow channel width, which may be narrower than a Basic Service Set (BSS) operating channel width of a BSS to which the non-AP STA belongs, e.g., as described below.

In some demonstrative aspects, device 102, device 140, and/or device 160 may be configured to implement one or more operations and/or functionalities of a reduced bandwidth communication mechanism, which may be configured to support operation of a non-AP STA, which is operating in a first channel width, to participate in a wider bandwidth transmission over a second channel width, which may be wider than the first channel width, e.g., as described below.

In some demonstrative aspects, the reduced bandwidth communication mechanism may be configured to support operation of a non-AP STA, which is operating in the first channel width, to participate in a wider bandwidth Orthogonal Frequency-Division Multiple Access (OFDMA) transmission over the second channel width, which may be wider than the first channel width, e.g., as described below.

In some demonstrative aspects, the reduced bandwidth communication mechanism may be configured to support operation of a non-AP STA, which is operating in a 40 Megahertz (MHz) channel width, to participate in a wider bandwidth Orthogonal Frequency-Division Multiple Access (OFDMA) transmission over a channel width of at least 80 MHz, e.g., as described below.

In some demonstrative aspects, device 102, device 140, and/or device 160 may be configured to implement one or more operations and/or functionalities, may be configured to support operation of a non-AP STA, e.g., a non-AP STA implemented by device 140, as a 40 MHz operating non-AP STA, e.g., as described below.

In some demonstrative aspects, device 102, device 140, and/or device 160 may be configured to implement one or more operations and/or functionalities, may be configured to support operation of a non-AP STA, e.g., a non-AP STA implemented by device 140, as a 40 MHz operating non-AP EHT STA, e.g., as described below.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP UHR STA, e.g., as described below.

In some demonstrative aspects, a non-AP STA, e.g., a non-AP STA implemented by device 140, may be configured to operate as, perform the role of, and/or perform one or more operations and/or functionalities of, a 40 MHz operating non-AP STA, e.g., as described below.

In some demonstrative aspects, the 40 MHz operating non-AP STA may include, for example, a non-AP STA, e.g., a non-AP EHT STA, a non-AP UHR STA and/or any other suitable type of non-AP STA, which supports an operating channel width up to 40 MHz in a current operating mode, e.g., as described below.

In some demonstrative aspects, the 40 MHz operating non-AP STA may include, for example, a non-AP STA, e.g., a non-AP EHT STA, a non-AP UHR STA and/or any other suitable type of non-AP STA, which indicates, e.g., to an AP, support for a 40 MHz channel width for the frequency band in which it is operating, e.g., as described below.

In some demonstrative aspects, the 40 MHz operating non-AP STA may include, for example, a non-AP STA, e.g., a non-AP EHT STA, a non-AP UHR STA and/or any other suitable type of non-AP STA, which is operating in a 40 MHz channel width mode, e.g., as described below.

In some demonstrative aspects, the 40 MHz operating non-AP STA may include, for example, a non-AP STA, e.g., a non-AP EHT STA, a non-AP UHR STA and/or any other suitable type of non-AP STA, which is not capable of 80 MHz operation; and/or a non-AP STA, e.g., a non-AP EHT STA, a non-AP UHR STA and/or any other suitable type of non-AP STA, that has reduced its operating channel width to 40 MHz, for example, using an Operating Mode Indication (OMI).

In other aspects, the 40 MHz operating non-AP STA may include any other non-AP STA, which may capable of operating over the 40 MHz channel width according to any other suitable additional or alternative requirements, and/or may perform any other additional or alternative functionalities.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP STA, which may participate in communication with an AP over a wider channel width, e.g., as described below.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP STA, which may participate in communication with an AP over channel width of at least 80 MHz, e.g., as described below.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP STA, which may participate in communication with an AP over a BSS operating channel width, e.g., of a BSS of the AP, which may be wider than 40 MHz, e.g., as described below.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP STA, which may participate in a wider bandwidth OFDMA, for example, over a BSS operating channel width wider than 40 MHz, e.g., as described below.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP STA, which may participate in a wider bandwidth EHT OFDMA transmission, for example, over a BSS operating channel width wider than 40 MHz, e.g., as described below.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP STA, which may participate in a wider bandwidth UHR OFDMA transmission, for example, over a BSS operating channel width wider than 40 MHz, e.g., as described below.

In some demonstrative aspects, device 102, device 140, and/or device 160 may be configured to implement one or more operations and/or functionalities, which may be configured to support operation of a non-AP STA, e.g., a non-AP STA implemented by device 140, as a 40 MHz operating non-AP STA, which may participate in a wider bandwidth HE OFDMA transmission, for example, over a BSS operating channel width wider than 40 MHz, e.g., as described below.

In some demonstrative aspects, a non-AP STA, e.g., a non-AP STA implemented by device 140, may be configured as a 40 MHz operating non-AP STA, e.g., a 40 MHz operating non-AP EHT STA or a 40 MHz operating non-AP UHR STA, which may participate in a wider bandwidth OFDMA, for example, to provide a technical solution to support the non-AP STA to reduce its operating channel width to 40 MHz, for example, to save power, e.g., by lowering the operation bandwidth.

In some demonstrative aspects, a non-AP STA, e.g., a non-AP STA implemented by device 140, may be configured as a 40 MHz operating non-AP STA, e.g., a 40 MHz operating non-AP EHT STA or a 40 MHz operating non-AP UHR STA, which may be allowed to operate in a primary 40 MHz channel of the wider BSS operating channel width, e.g., as described below.

In some demonstrative aspects, a non-AP STA, e.g., a non-AP STA implemented by device 140, may be configured as a 40 MHz operating non-AP STA, e.g., a 40 MHz operating non-AP EHT STA or a 40 MHz operating non-AP UHR STA, which may be allowed to operate, e.g., might operate, in a secondary 40 MHz channel of the wider BSS operating channel width, e.g., as described below.

In some demonstrative aspects, the 40 MHz operating non-AP STA, e.g., the 40 MHz operating non-AP EHT STA or 40 MHz operating non-AP UHR STA, may operate in the primary 40 MHz channel, and may be allowed to operate, e.g., might operate, in a secondary 40 MHz channel, which does not include, for example, any inactive 20 MHz subchannel, e.g., as described below.

In some demonstrative aspects, the 40 MHz operating non-AP STA, e.g., the 40 MHz operating non-AP EHT STA or 40 MHz operating non-AP UHR STA, may be allowed to operate, e.g., might operate, in the secondary 40 MHz channel, which does not include any inactive 20 MHz subchannel, for example, when the 40 MHz operating non-AP STA sets a Subchannel Selective Transmission (SST) or dynamic channel operation to be true, e.g., as described below.

In some demonstrative aspects, device 102, device 140, and/or device 160 may be configured to implement one or more operations and/or functionalities in accordance with a protocol and/or specification, e.g., an IEEE 802.11 Specification and/or any other specification, which may define the SST or dynamic channel operation may be supported for a 40 MHz operating STA to operate in a non-primary 40 MHz, e.g., as described below.

In some demonstrative aspects, controller 154 may be configured to control, trigger, cause, and/or instruct a non-AP STA implemented by device 140 to operate in a 40 MHz operating mode, as a 40 MHz operating non-AP STA, which supports a 40 MHz operating channel width, e.g., as described below.

In some demonstrative aspects, controller 154 may be configured to control, trigger, cause, and/or instruct the non-AP STA implemented by device 140 to operate as the 40 MHz operating non-AP STA, which may be capable to process allocation information from an AP, e.g., an AP implemented by device 102, for example, to identify a Resource Unit (RU) or Multiple RU (MRU) (RU/MRU) allocated to the 40 MHz operating non-AP STA within the 40 MHz operating channel width, e.g., as described below.

In some demonstrative aspects, controller 154 may be configured to control, trigger, cause, and/or instruct the non-AP STA implemented by device 140 to operate as the 40 MHz operating non-AP STA, which may be capable to communicate data over the RU/MRU allocated to the 40 MHz operating non-AP STA, for example, as part of a wider bandwidth OFDMA transmission over a channel bandwidth of at least 80 MHz, e.g., as described below.

In some demonstrative aspects, the wider bandwidth OFDMA transmission over the channel bandwidth of at least 80 MHz may include a 80 MHz OFDMA transmission over a 80 MHz channel width, e.g., as described below.

In some demonstrative aspects, the wider bandwidth OFDMA transmission over the channel bandwidth of at least 80 MHz may include a 80+80 MHz OFDMA transmission over a 80+80 MHz channel width, e.g., as described below.

In some demonstrative aspects, the wider bandwidth OFDMA transmission over the channel bandwidth of at least 80 MHz may include a 160 MHz OFDMA transmission over a 160 MHz channel width, e.g., as described below.

In some demonstrative aspects, the wider bandwidth OFDMA transmission over the channel bandwidth of at least 80 MHz may include a 320 MHz OFDMA transmission over a 320 MHz channel width, e.g., as described below.

In other aspects, the wider bandwidth OFDMA transmission over the channel bandwidth of at least 80 MHz may include any other wider bandwidth OFDMA transmission over any other channel width of at least 80 MHz, e.g., as described below.

In some demonstrative aspects, controller 154 may be configured to control, trigger, cause, and/or instruct the non-AP STA implemented by device 140 to operate as a 40 MHz operating non-AP EHT STA, e.g., as described below.

In some demonstrative aspects, controller 154 may be configured to control, trigger, cause, and/or instruct the non-AP STA implemented by device 140 to operate as a 40 MHz operating non-AP UHR STA, e.g., as described below.

In other aspects, controller 154 may be configured to control, trigger, cause, and/or instruct the non-AP STA implemented by device 140 to operate as any other type of 40 MHz operating non-AP STA.

In some demonstrative aspects, controller 154 may be configured to control, trigger, cause, and/or instruct the non-AP STA implemented by device 140 to transmit to the AP operating channel width information to indicate that the non-AP STA has, operates on, and/or supports the 40 MHz operating channel width, e.g., as described below.

In some demonstrative aspects, controller 154 may be configured to control, trigger, cause, and/or instruct the non-AP STA implemented by device 140 to transmit to the AP supported channel width information, which may be configured, for example, to indicate that the non-AP STA supports the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be capable to transmit an Uplink (UL) transmission to the AP, for example, as part of a wider bandwidth UL OFDMA transmission over the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be capable to transmit a preamble and UL data to the AP, for example, over the RU/MRU allocated to the 40 MHz operating non-AP STA, for example, as part of a wider bandwidth UL OFDMA transmission over the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be capable to process a Downlink (DL) transmission from the AP, for example, as part of a wider bandwidth DL OFDMA transmission over the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be capable to process a received preamble and DL data from the AP, for example, over the RU/MRU allocated to the 40 MHz operating non-AP STA, for example, as part of a wider bandwidth DL OFDMA transmission over the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be configured to operate in a primary 40 MHz channel of the channel bandwidth of at least 80 MHz, e.g., as described below.

In some demonstrative aspects, controller 154 may be configured to control, trigger, cause, and/or instruct the non-AP STA implemented by device 140 to allow the 40 MHz operating non-AP STA to operate in a secondary 40 MHz channel of the channel bandwidth of at least 80 MHz, e.g., as described below.

In some demonstrative aspects, controller 154 may be configured to control, trigger, cause, and/or instruct the non-AP STA implemented by device 140 to allow the 40 MHz operating non-AP STA to operate in the secondary 40 MHz channel of the channel bandwidth of at least 80 MHz, for example, based on a determination that the secondary 40 MHz channel does not include an active 20 MHz subchannel, e.g., as descried below.

In some demonstrative aspects, controller 154 may be configured to control, trigger, cause, and/or instruct the non-AP STA implemented by device 140 to allow the 40 MHz operating non-AP STA to operate in the secondary 40 MHz channel of the channel bandwidth of at least 80 MHz, for example, based on a determination that the non-AP STA supports a Subchannel Selective Transmission (SST) mode, e.g., as described below.

In some demonstrative aspects, controller 154 may be configured to control, trigger, cause, and/or instruct the non-AP STA implemented by device 140 to allow the 40 MHz operating non-AP STA to operate in the secondary 40 MHz channel of the channel bandwidth of at least 80 MHz, for example, based on a determination that the non-AP STA supports a dynamic channel operation mode, e.g., as described below.

In some demonstrative aspects, controller 154 may be configured to control, trigger, cause, and/or instruct the non-AP STA implemented by device 140 to operate as the 40 MHz operating non-AP STA, which may be capable to support all RU/MRU sizes within the 40 MHz operating channel width, for example, when participating in the wider bandwidth OFDMA transmission over the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be configured to setup with the AP an SST mode, e.g., as described below.

In some demonstrative aspects, controller 154 may be configured to control, trigger, cause, and/or instruct the non-AP STA implemented by device 140 to operate as the 40 MHz operating non-AP STA, which may be configured to setup the SST mode with the AP, for example, by negotiating a trigger-enabled Target Wake Time (TWT) agreement with the AP, e.g., as described below.

In some demonstrative aspects, controller 154 may be configured to control, trigger, cause, and/or instruct the non-AP STA implemented by device 140 to operate as the 40 MHz operating non-AP STA, which may be configured to negotiate the trigger-enabled TWT agreement with the AP, for example, by transmitting to the AP a TWT request, e.g., as described below.

In some demonstrative aspects, the TWT request may include a TWT channel field having up to 2 bits set to “1”, for example, to indicate a requested 40 MHz channel for RU allocations for the 40 MHz operating non-AP STA, e.g., as described below.

In some demonstrative aspects, controller 154 may be configured to control, trigger, cause, and/or instruct the non-AP STA implemented by device 140 to operate as the 40 MHz operating non-AP STA, which may be configured to set a boundary of the requested 40 MHz channel, for example, to align with a boundary of an 80 MHz channel in the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be configured to operate in a dynamic channel operation mode over a contiguous 40 MHz channel, e.g., as described below.

In some demonstrative aspects, controller 154 may be configured to control, trigger, cause, and/or instruct the non-AP STA implemented by device 140 to operate as the 40 MHz operating non-AP STA, which may be configured to operate in a dynamic channel operation mode over a contiguous 40 MHz channel having a boundary aligned with a boundary of an 80 MHz channel in the channel bandwidth of at least 80 MHz, e.g., as described below.

In some demonstrative aspects, controller 154 may be configured to control, trigger, cause, and/or instruct the non-AP STA implemented by device 140 to transmit to the AP a capability bit, which may be configured, for example, to indicate that the non-AP STA supports operation in the 40 MHz operating mode while participating in the wider bandwidth OFDMA transmission over the channel bandwidth of at least 80 MHz, e.g., as described below.

In some demonstrative aspects, controller 154 may be configured to control, trigger, cause, and/or instruct the non-AP STA implemented by device 140 to operate as the 40 MHz operating non-AP STA, which may be capable to support communication of the data over the RU/MRU allocated to the 40 MHz operating non-AP STA as part of the wider bandwidth OFDMA transmission over any one of a 80 MHz channel bandwidth, a 160 MHz channel bandwidth, and a 320 MHz channel bandwidth, e.g., as described below.

In some demonstrative aspects, controller 154 may be configured to control, trigger, cause, and/or instruct the non-AP STA implemented by device 140 to operate as the 40 MHz operating non-AP STA, which may be capable to support communication of the data over the RU/MRU allocated to the 40 MHz operating non-AP STA as part of a wider bandwidth EHT OFDMA transmission over any one of a 80 MHz channel bandwidth, a 160 MHz channel bandwidth, and a 320 MHz channel bandwidth, e.g., as described below.

In some demonstrative aspects, controller 154 may be configured to control, trigger, cause, and/or instruct the non-AP STA implemented by device 140 to operate as the 40 MHz operating non-AP STA, which may be capable to support communication of the data over the RU/MRU allocated to the 40 MHz operating non-AP STA as part of a wider bandwidth UHR OFDMA transmission over any one of a 80 MHz channel bandwidth, a 160 MHz channel bandwidth, and a 320 MHz channel bandwidth, e.g., as described below.

In some demonstrative aspects, controller 154 may be configured to control, trigger, cause, and/or instruct the non-AP STA implemented by device 140 to operate as the 40 MHz operating non-AP STA, which may be capable to support communication of the data over the RU/MRU allocated to the 40 MHz operating non-AP STA as part of a wider bandwidth HE OFDMA transmission, e.g., as described below.

In some demonstrative aspects, controller 154 may be configured to control, trigger, cause, and/or instruct the non-AP STA implemented by device 140 to operate as the 40 MHz operating non-AP STA, which may be capable to support a tone mapping of a 26-tone RU, a 52-tone RU, a 106-tone RU, a 242-tone RU, and/or a 484-tone RU, for example, for a 40 MHz HE PPDU, for example, in a 2.4 GHz band, a 5 GHz band, and/or a 6 Ghz band, e.g., as described below.

In some demonstrative aspects, controller 154 may be configured to control, trigger, cause, and/or instruct the non-AP STA implemented by device 140 to operate as the 40 MHz operating non-AP STA, which may be capable to support a tone mapping of a 484-tone RU, for example, for reception of a 80 MHz HE Multi User (MU) PPDU, an 80+80 MHz HE MU PPDU, and/or a 160 MHz HE MU PPDU, for example, in a 5 GHz band, and/or a 6 Ghz band.

In some demonstrative aspects, controller 154 may be configured to control, trigger, cause, and/or instruct the non-AP STA implemented by device 140 to operate as the 40 MHz operating non-AP STA, which may be capable to support communication of the data over the RU/MRU allocated to the 40 MHz operating non-AP STA, for example, as part of the wider bandwidth HE OFDMA transmission over any one of a 80 MHz channel bandwidth, a 160 MHz channel bandwidth, and an 80+80 MHz channel bandwidth, e.g., as described below.

In some demonstrative aspects, device 102, device 140, and/or device 160 may be configured to implement one or more operations and/or functionalities in accordance with a mechanism, which may define one or more operations and/or functionalities of a 40 MHz operating non-AP STA, e.g., a 40 MHz operating non-AP EHT STA or a 40 MHz operating non-AP UHR STA (also referred to as “a 40 MHz operating non-AP EHT/UHR STA”), participating in wider bandwidth OFDMA, e.g., as described below.

In some demonstrative aspects, it may be defined that a 40 MHz operating non-AP EHT/UHR STA is a non-AP EHT/UHR STA that reduces its operating channel width to 40 MHz.

In some demonstrative aspects, it may be defined that the supported channel width of an EHT/UHR STA is to be indicated, for example, in a Supported Channel Width Set subfield, for example, in an HE PHY Capabilities Information field, e.g., in an HE Capabilities element; and/or in a Supported for 320 MHz in 6 GHz subfield, for example, in an EHT/UHR PHY Capabilities Information field, e.g., in an EHT Capabilities element; and/or an operating channel width identified by a CHANNEL_WIDTH parameter may be contained, for example, in a PHYCONFIG_VECTOR of an EHT/UHR STA.

In some demonstrative aspects, device 102, device 140, and/or device 160 may be configured to implement one or more operations and/or functionalities in accordance with a mechanism, which may define one or more operations and/or functionalities of a 40 MHz operating non-AP STA, e.g., a 40 MHz operating non-AP EHT/UHR STA, which may participate in a wider bandwidth EHT/UHR OFDMA transmission, e.g., as described below.

In some demonstrative aspects, it may be defined that a 40 MHz operating non-AP EHT/UHR STA shall be able to participate in 80 MHz, 160 MHz, and 320 MHz EHT/UHR DL and UL OFDMA transmissions.

In some demonstrative aspects, it may be defined that an EHT/UHR AP, e.g., an AP implemented by device 102, with a CHANNEL_WIDTH parameter greater than 40 MHz shall be able to allocate an RU or MRU (RU/MRU) within the 40 MHz bandwidth of the non-AP EHT/UHR STA, e.g., a non-AP STA implemented by device 140, for example, in a 80 MHz, a 160 MHz or a 320 MHz EHT/UHR MU or EHT/UHR Trigger Based (TB) PPDU.

In some demonstrative aspects, it may be defined that a 40 MHz operating non-AP EHT/UHR STA operates in the primary 40 MHz channel and might operate in the secondary 40 MHz channel that does not include any inactive 20 MHz subchannel.

In some demonstrative aspects, it may be defined that the 40 MHz operating non-AP EHT/UHR STA might operate in the secondary 40 MHz channel that does not include any inactive 20 MHz subchannel, for example, when the 40 MHz operating non-AP EHT/UHR STA sets an SST implemented indication (dot11HESubchannelSelectiveTransmissionImplemented) to be true.

For example, SST support for a 40 MHz operating STA to operate in a non-primary 40 MHz shall be defined for UHR operation, e.g., as described below.

In some demonstrative aspects, it may be defined that the 40 MHz operating non-AP EHT/UHR STA might operate in the secondary 40 MHz channel that does not include any inactive 20 MHz subchannel, for example, when the 40 MHz operating non-AP EHT/UHR STA sets a dynamic channel operation mode to be true.

For example, dynamic channel operation mode may be defined for UHR operation, e.g., as described below.

In some demonstrative aspects, it may be defined that an EHT/UHR AP, e.g., an AP implemented by device 102, does not allocate an RU or MRU in the secondary 40 MHz channels, for example, of a 80 MHz, 160 MHz or 320 MHz EHT/UHR MU or EHT/UHR TB PPDU, for example, to a 40 MHz operating non-AP EHT/UHR STA, for example, if the 40 MHz operating non-AP EHT/UHR STA does not support SST or dynamic channel operation for a 40 MHz operating STA to operate in a non-primary 40 MHz channel; or if the 40 MHz operating non-AP EHT/UHR STA does support SST and/or dynamic channel access for a 40 MHz operating STA to operate in a non-primary 40 MHz channel but has not set up SST operation, for example, by following an HE subchannel selective transmission procedure on the secondary 40 MHz channel or dynamic channel operation with the EHT/UHR AP; or if there is an inactive 20 MHz subchannel within the secondary 40 MHz channel.

In some demonstrative aspects, it may be defined that a 40 MHz operating non-AP EHT/UHR STA shall support all RU and MRU sizes within its operating 40 MHz channel, for example, when participating in 80 MHz, 160 MHz or 320 MHz EHT/UHR DL and UL OFDMA transmissions.

In some demonstrative aspects, it may be defined that a 40 MHz operating non-AP EHT/UHR STA shall be able to transmit the preamble and data in the allocated RU or MRU within its operating 40 MHz channel, for example, in an 80 MHz, 160 MHz or 320 MHz ETH/UHR TB PPDU.

In some demonstrative aspects, it may be defined that a 40 MHz operating non-AP EHT/UHR STA shall be able to support the reception of the preamble and data in the allocated RU or MRU within its operating 40 MHz channel, for example, in an 80 MHz, 160 MHz or 320 MHz EHT/UHR MU PPDU.

In some demonstrative aspects, it may be defined that a functionality of a 40 MHz operating non-AP EHT/UHR STAs participating in a wider bandwidth OFDMA is to be defined a as mandatory feature, e.g., for any non-AP UHR STA.

In some demonstrative aspects, it may be defined that a client, e.g., a 40 MHz operating non-AP EHT/UHR STA, is to support the use of a capability bit, which may be used for the client to indicate whether it supports 40 MHz operation participating in wider bandwidth OFDMA transmission.

In some demonstrative aspects, device 102, device 140, and/or device 160 may be configured to implement one or more operations and/or functionalities in accordance with a mechanism, which may define one or more operations and/or functionalities of a 40 MHz operating non-AP STA, e.g., a 40 MHz operating non-AP EHT/UHR STA, which may participate in a wider bandwidth HE OFDMA transmission, e.g., as described below.

In some demonstrative aspects, it may be defined that a 40 MHz operating non-AP UHR STA shall be able to participate in 80 MHz, 160 MHz, and 80+80 MHz HE DL and UL OFDMA transmissions.

In some demonstrative aspects, it may be defined that an EHT/UHR AP, e.g., an AP implemented by device 102, with a CHANNEL_WIDTH parameter greater than 40 MHz shall be able to allocate an RU or MRU within the 40 MHz bandwidth of the non-AP EHT/UHR STA, e.g., a non-AP STA implemented by device 140, in an 80 MHz, 160 MHz, or 80+80 MHz HE MU or HE TB PPDU.

In some demonstrative aspects, it may be defined that a 40 MHz operating non-AP UHR STA shall support tone mapping of 26-tone RU, 52-tone RU, 106-tone RU, 242-tone RU, and 484-tone RU, for example, for a 40 MHz HE PPDU in the 2.4 GHz, 5 GHz, and 6 GHz frequency bands.

In some demonstrative aspects, it may be defined that a 40 MHz operating non-AP UHR STA indicates support for tone mapping of 26-tone RU, 52-tone RU, 106-tone RU, and 242-tone RU for 80+80 MHz PPDU and 80/160 MHz HE PPDUs, for example, with the exception of RUs that are restricted from operation, e.g., as may be defined according to RU restrictions for 40 MHz operating non-AP UHR STA in 80+80 MHz PPDU and 80/160 MHz HE PPDUs.

In some demonstrative aspects, it may be defined that a 40 MHz operating non-AP UHR STA may support tone mapping of 484-tone RU, for example, for the reception of a 80 MHz, 80+80 MHz, and/or 160 MHz HE MU in the 5 GHz and 6 GHz bands.

In some demonstrative aspects, it may be defined that the 40 MHz operating non-AP UHR STA may be configured to indicate support of the tone mapping of 484-tone RU, for example, in a Supported Channel Width Set subfield in an HE PHY Capabilities Information field, for example, in an HE Capabilities element.

In some demonstrative aspects, one or more RU restrictions may be defined, for example, for a 40 MHz operating non-AP UHR STA, for example, in 80+80 MHz PPDU and/or 80/160 MHz HE PPDUs, e.g., as described below.

In some demonstrative aspects, for example, if a 40 MHz operating non-AP UHR STA is the receiver of an 80 MHz, 80+80 MHz, or 160 MHz HE MU PPDU, or the transmitter of an 80 MHz, 80+80 MHz, or 160 MHz HE TB PPDU, then an RU tone mapping in 40 MHz channel width may not be aligned with the 80 MHz, 80+80 MHz or 160 MHz RU tone mapping.

In some demonstrative aspects, it may be defined that an AP, e.g., an AP implemented by device 102, shall not assign one or more RUs (“40 MHz operating non-AP UHR STA excluded RUs”) to a 40 MHz operating non-AP UHR STA.

In some demonstrative aspects, it may be defined that an AP, e.g., an AP implemented by device 102, shall not assign, e.g., may select to exclude from an assignment, one or more, e.g., some or all, of the following excluded RUs to a 40 MHz operating non-AP UHR STA:
26-tone RU 10, 19, 28 of an 80 MHz HE MU PPDU or HE TB PPDU
26-tone RU 19 of the lower 80 MHz of an 80+80 MHz and 160 MHz HE MU PPDU or HE TB PPDU
26-tone RU 19 of the upper 80 MHz of an 80+80 MHz and 160 MHz HE MU PPDU or HE TB PPDU
52-tone RU 5, 12 of an 80 MHz HE MU PPDU or HE TB PPDU
52-tone RU 5, 12 of the lower 80 MHz of an 80+80 MHz and 160 MHz HE MU PPDU or HE TB PPDU
52-tone RU 5, 12 of the upper 80 MHz of an 80+80 MHz and 160 MHz HE MU PPDU or HE TB PPDU
106-tone RU 3, 6 of an 80 MHz HE MU PPDU or HE TB PPDU
106-tone RU 3, 6 of the lower 80 MHz of an 80+80 MHz and 160 MHz HE MU PPDU or HE TB PPDU
106-tone RU 3, 6 of the upper 80 MHz of an 80+80 MHz and 160 MHz HE MU PPDU or HE TB PPDU
242-tone RU 2, 3 of an 80 MHz HE MU PPDU or HE TB PPDU
242-tone RU 2, 3 of the lower 80 MHz of an 80+80 MHz and 160 MHz HE MU PPDU or HE TB PPDU
242-tone RU 2, 3 of the upper 80 MHz of an 80+80 MHz and 160 MHz HE MU PPDU or HE TB PPDU

For example, the above-mentioned RU indices may be defined, for example, according to a table of “Data and pilot subcarrier indices for RUs in a 40 MHz HE PPDU and in a non-OFDMA 40 MHz HE PPDU”, e.g., in accordance with an IEEE 802.11ax Specification.

In other aspects, any other additional or alternative RUs may be defined to be excluded from RU assignments to a 40 MHz operating non-AP UHR STA.

In some demonstrative aspects, device 102, device 140, and/or device 160 may be configured to implement one or more operations and/or functionalities in accordance with a mechanism, which may define one or more operations and/or functionalities of an SST operation for 40 MHz operating non-AP STA, e.g., as described below.

In some demonstrative aspects, it may be defined that an HE subchannel selective transmission operation, e.g., in accordance with an IEEE 802.11 Specification, should be extended to an 40 MHz operating non-AP STA and/or an 160 MHz operating non-AP STA.

In some demonstrative aspects, it may be defined that an HE subchannel selective transmission operation, e.g., in accordance with an IEEE 802.11 Specification, should be extended for an 80 MHz operating non-AP STA, for example, to support 320 MHz in UHR.

In some demonstrative aspects, it may be defined that an UHR SST non-AP STA and an UHR SST AP may set up SST operation, for example, by negotiating a trigger-enabled TWT, for example, in accordance with a procedure for individual TWT agreements, for example, according to one or more, e.g., some or all, of the rules and/or operations defined below.

In some demonstrative aspects, it may be defined that a TWT request, e.g., from the non-AP STA, may have a TWT Channel field with up to 2 bits set to 1, for example, to indicate the 40 MHz channel requested to contain the RU allocations addressed to the UHR SST non-AP STA that is a 40 MHz operating STA.

In some demonstrative aspects, it may be defined that the 2 bits set to 1 should indicate a contiguous 40 MHz channel.

In some demonstrative aspects, it may be defined that one of the boundaries of the 40 MHz channel shall align with the boundary of the 80 MHz channel. For example, this alignment may provide a technical solution to avoid center 40 MHz indication in an 80 MHz channel.

In some demonstrative aspects, it may be defined that, for example, based on the above rules, there may be a plurality of possible locations for the 40 MHz channel, for example, including 8 possible locations in a 320 MHz channel width, 4 possible location in a 160 MHz channel width, and 2 possible locations in a 80 MHz channel width.

In some demonstrative aspects, it may be defined that the TWT request may have a TWT Channel field with up to 4 bits set to 1, for example, to indicate the 80 MHz channel requested to contain the RU allocations addressed to the UHR SST non-AP STA that is a 80 MHz operating STA.

In some demonstrative aspects, it may be defined that the 4 bits set to 1 should indicate a contiguous 80 MHz channel.

In some demonstrative aspects, it may be defined that one of the boundaries of the 80 MHz channel shall align with the boundary of the 160 MHz channel. For example, this alignment may provide a technical solution to avoid center 80 MHz indication in a 160 MHz channel.

In some demonstrative aspects, it may be defined that, for example, based on the above rules, there may be a plurality of possible locations for the 80 MHz channel, for example, including 4 possible locations in a 320 MHz channel width, and 2 possible locations in a 160 MHz channel width.

In some demonstrative aspects, it may be defined that the TWT request may have a TWT Channel field with all 8 LSBs or all 8 MSBs set to 1, for example, to indicate whether the primary 160 MHz channel or the secondary 160 MHz channel is requested to contain the RU allocations addressed to the UHR SST non-AP STA that is an 160 MHz operating STA.

In some demonstrative aspects, it may be defined that a TWT response, e.g., from the AP implemented by device 102, shall have a TWT Channel field with up to 2 bits set to 1, for example, to indicate the 40 MHz channel that will contain the RU allocations addressed to the UHR SST non-AP STA that is a 40 MHz operating STA.

In some demonstrative aspects, it may be defined that the 2 bits set to 1 should indicate a contiguous 40 MHz channel.

In some demonstrative aspects, it may be defined that one of the boundaries of the 40 MHz channel shall align with the boundary of the 80 MHz channel. For example, this alignment may provide a technical solution to avoid center 40 MHz indication in an 80 MHz channel.

In some demonstrative aspects, it may be defined that, for example, based on the above rules, there may be a plurality of possible locations for the 40 MHz channel, for example, including 8 possible locations in a 320 MHz channel width, 4 possible location in a 160 MHz channel width, and 2 possible locations in a 80 MHz channel width.

In some demonstrative aspects, it may be defined that the TWT response shall have a TWT Channel field with up to 4 bits set to 1, for example, to indicate the 80 MHz channel that will contain the RU allocations addressed to the UHR SST non-AP STA that is a 80 MHz operating STA.

In some demonstrative aspects, it may be defined that the 4 bits set to 1 should indicate a contiguous 80 MHz channel.

In some demonstrative aspects, it may be defined that one of the boundaries of the 80 MHz channel shall align with the boundary of the 160 MHz channel. For example, this alignment may provide a technical solution to avoid center 80 MHz indication in a 160 MHz channel.

In some demonstrative aspects, it may be defined that, for example, based on the above rules, there may be a plurality of possible locations for the 80 MHz channel, for example, including 4 possible locations in a 320 MHz channel width, and 2 possible locations in a 160 MHz channel width.

In some demonstrative aspects, it may be defined that the TWT response shall have a TWT Channel field with all 8 LSBs or all 8 MSBs set to 1, for example, to indicate whether the primary 160 MHz channel or the secondary 160 MHz channel will contain the RU allocations addressed to the UHR SST non-AP STA that is a 160 MHz operating STA.

In some demonstrative aspects, device 102, device 140, and/or device 160 may be configured to implement one or more operations and/or functionalities in accordance with a mechanism, which may define one or more operations and/or functionalities of dynamic subchannel operation for a 20/40/80/160 MHz operating non-AP STA, e.g., as described below.

In some demonstrative aspects, it may be defined that it may be possible for an AP, e.g., an AP implemented by device 102, to dynamically allocate a non-AP STA, e.g., a non-AP STA implemented by device 140, to a specific subchannel for a following TXOP.

In some demonstrative aspects, one or more of the following rules nay be defined for an 20/40/80/160 MHz operating non-AP STA:
a 20 MHz operating non-AP STA can be allocated to any 20 MHz
a 40 MHz operating non-AP STA can be allocated to a contiguous 40 MHz channel with one of the boundaries aligned with the 80 MHz boundary
an 80 MHz operating non-AP STA can be allocated to a contiguous 80 MHz channel with one of the boundaries aligned with the 160 MHz boundary
a 160 MHz operating non-AP STA can be allocated to a contiguous 160 MHz channel with one of the boundaries aligned with the 320 MHz boundary.

In some demonstrative aspects, it may be defined that static puncturing may be applied, for example, on top of the indicated channel, for example, meaning for SST or dynamic subchannel operation no operation on the 20 MHz that is indicated punctured by the AP.

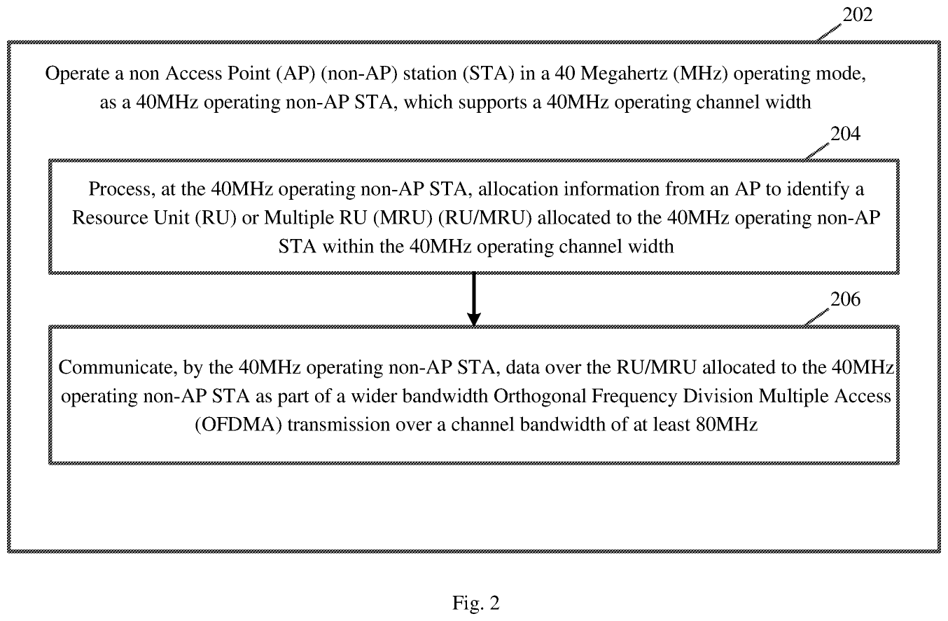

Reference is made to FIG. 2, which schematically illustrates a method of a 40 MHz operating non-AP STA, in accordance with some demonstrative aspects. For example, one or more of the operations of the method of FIG. 2 may be performed by one or more elements of a system, e.g., system 100 (FIG. 1), for example, one or more wireless devices, e.g., device 102 (FIG. 1), device 140 (FIG. 1), and/or device 160 (FIG. 1), a controller, e.g., controller 124 (FIG. 1) and/or controller 154 (FIG. 1), a radio, e.g., radio 114 (FIG. 1) and/or radio 144 (FIG. 1), and/or a message processor, e.g., message processor 128 (FIG. 1) and/or message processor 158 (FIG. 1).

As indicated at block 202, the method may include operating a non-AP STA in a 40 MHz operating mode, as a 40 MHz operating non-AP STA, which supports a 40 MHz operating channel width. For example, controller 154 (FIG. 1) may be configured to cause, trigger, and/or control a non-AP STA implemented by device 140 (FIG. 1) to operate in the 40 MHz operating mode, as a 40 MHz operating non-AP STA, which supports a 40 MHz operating channel width, e.g., as described above.

As indicated at block 204, the method may include processing at the 40 MHz operating non-AP STA allocation information from an AP to identify a Resource Unit (RU) or Multiple RU (MRU) (RU/MRU) allocated to the 40 MHz operating non-AP STA within the 40 MHz operating channel width. For example, controller 154 (FIG. 1) may be configured to cause the non-AP STA implemented by device 140 (FIG. 1) to process the allocation information from the AP implemented by device 102, for example, to identify an RU/MRU allocated to the 40 MHz operating non-AP STA within the 40 MHz operating channel width, e.g., as described above.

As indicated at block 206, the method may include communicating data over the RU/MRU allocated to the 40 MHz operating non-AP STA as part of a wider bandwidth Orthogonal Frequency Division Multiple Access (OFDMA) transmission over a channel bandwidth of at least 80 MHz. For example, controller 154 (FIG. 1) may be configured to cause the non-AP STA implemented by device 140 (FIG. 1) to communicate data over the RU/MRU allocated to the 40 MHz operating non-AP STA as part of a wider bandwidth OFDMA transmission over a channel bandwidth of at least 80 MHz, e.g., as described above.

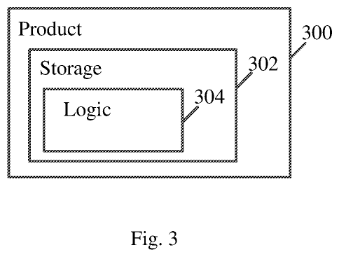

Reference is made to FIG. 3, which schematically illustrates a product of manufacture 300, in accordance with some demonstrative aspects. Product 300 may include one or more tangible computer-readable (“machine-readable”) non-transitory storage media 302, which may include computer-executable instructions, e.g., implemented by logic 304, operable to, when executed by at least one computer processor, enable the at least one computer processor to implement one or more operations at device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1); to cause device 102 (FIG. 1), device 140 (FIG. 1), device 160 (FIG. 1), controller 124 (FIG. 1), controller 154 (FIG. 1), message processor 128 (FIG. 1), message processor 158 (FIG. 1), radio 114 (FIG. 1), radio 144 (FIG. 1), transmitter 118 (FIG. 1), transmitter 148 (FIG. 1), receiver 116 (FIG. 1), and/or receiver 146 (FIG. 1) to perform, trigger and/or implement one or more operations and/or functionalities; and/or to perform, trigger and/or implement one or more operations and/or functionalities described with reference to the FIG. 1 and/or FIG. 2, and/or one or more operations described herein. The phrases “non-transitory machine-readable medium” and “computer-readable non-transitory storage media” may be directed to include all machine and/or computer readable media, with the sole exception being a transitory propagating signal.

In some demonstrative aspects, product 300 and/or machine readable storage media 302 may include one or more types of computer-readable storage media capable of storing data, including volatile memory, non-volatile memory, removable or non-removable memory, erasable or non-erasable memory, writeable or re-writeable memory, and the like. For example, machine readable storage media 302 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a disk, a hard drive, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 304 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 304 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes an apparatus comprising logic and circuitry configured to cause a non Access Point (AP) (non-AP) station (STA) to operate in a 40 Megahertz (MHz) operating mode, as a 40 MHz operating non-AP STA, which supports a 40 MHz operating channel width, and which is capable to process allocation information from an AP to identify a Resource Unit (RU) or Multiple RU (MRU) (RU/MRU) allocated to the 40 MHz operating non-AP STA within the 40 MHz operating channel width; and communicate data over the RU/MRU allocated to the 40 MHz operating non-AP STA as part of a wider bandwidth Orthogonal Frequency Division Multiple Access (OFDMA) transmission over a channel bandwidth of at least 80 MHz.

Example 2 includes the subject matter of Example 1, and optionally, wherein the 40 MHz operating non-AP STA is capable to transmit a preamble and Uplink (UL) data to the AP over the RU/MRU allocated to the 40 MHz operating non-AP STA as part of a wider bandwidth UL OFDMA transmission over the channel bandwidth of at least 80 MHz.

Example 3 includes the subject matter of Example 1 or 2, and optionally, wherein the 40 MHz operating non-AP STA is capable to process a received preamble and Downlink (DL) data from the AP over the RU/MRU allocated to the 40 MHz operating non-AP STA as part of a wider bandwidth DL OFDMA transmission over the channel bandwidth of at least 80 MHz.

Example 4 includes the subject matter of any one of Examples 1-3, and optionally, wherein the 40 MHz operating non-AP STA is configured to operate in a primary 40 MHz channel of the channel bandwidth of at least 80 MHz.

Example 5 includes the subject matter of any one of Examples 1-4, and optionally, wherein the apparatus is configured to allow the 40 MHz operating non-AP STA to operate in a secondary 40 MHz channel of the channel bandwidth of at least 80 MHz, based on a determination that the secondary 40 MHz channel does not include an active 20 MHz subchannel.

Example 6 includes the subject matter of Example 5, and optionally, wherein the apparatus is configured to allow the 40 MHz operating non-AP STA to operate in the secondary 40 MHz channel of the channel bandwidth of at least 80 MHz, based on a determination that the non-AP STA supports at least one of a Subchannel Selective Transmission (SST) mode or a dynamic channel operation mode.

Example 7 includes the subject matter of any one of Examples 1-6, and optionally, wherein the 40 MHz operating non-AP STA is capable to support all RU/MRU sizes within the 40 MHz operating channel width when participating in the wider bandwidth OFDMA transmission over the channel bandwidth of at least 80 MHz.

Example 8 includes the subject matter of any one of Examples 1-7, and optionally, wherein the 40 MHz operating non-AP STA is configured to setup with the AP a Subchannel Selective Transmission (SST) mode by negotiating a trigger-enabled Target Wake Time (TWT) agreement.

Example 9 includes the subject matter of Example 8, and optionally, wherein the 40 MHz operating non-AP STA is configured to transmit to the AP a TWT request comprising a TWT channel field having up to 2 bits set to “1” to indicate a requested 40 MHz channel for RU allocations for the 40 MHz operating non-AP STA.

Example 10 includes the subject matter of Example 9, and optionally, wherein the apparatus is configured to cause the 40 MHz operating non-AP STA to set a boundary of the requested 40 MHz channel to align with a boundary of an 80 MHz channel in the channel bandwidth of at least 80 MHz.

Example 11 includes the subject matter of any one of Examples 1-10, and optionally, wherein the 40 MHz operating non-AP STA is configured to operate in a dynamic channel operation mode over a contiguous 40 MHz channel having a boundary aligned with a boundary of an 80 MHz channel in the channel bandwidth of at least 80 MHz.

Example 12 includes the subject matter of any one of Examples 1-11, and optionally, wherein the apparatus is configured to cause the non-AP STA to transmit to the AP a capability bit configured to indicate that the non-AP STA supports operation in the 40 MHz operating mode while participating in the wider bandwidth OFDMA transmission over the channel bandwidth of at least 80 MHz.

Example 13 includes the subject matter of any one of Examples 1-12, and optionally, wherein the 40 MHz operating non-AP STA is capable to support communication of the data over the RU/MRU allocated to the 40 MHz operating non-AP STA as part of the wider bandwidth OFDMA transmission over any one of a 80 MHz channel bandwidth, a 160 MHz channel bandwidth, and a 320 MHz channel bandwidth.

Example 14 includes the subject matter of Example 13, and optionally, wherein the wider bandwidth OFDMA transmission comprises an Extremely High Throughput (EHT) OFDMA transmission or an Ultra High Reliability (UHR) OFDMA transmission.

Example 15 includes the subject matter of any one of Examples 1-12, and optionally, wherein the wider bandwidth OFDMA transmission comprises a High Efficiency (HE) OFDMA transmission.

Example 16 includes the subject matter of Example 15, and optionally, wherein the 40 MHz operating non-AP STA is capable to support a tone mapping of a 26-tone RU, a 52-tone RU, a 106-tone RU, a 242-tone RU, and a 484-tone RU for a 40 MHz HE Physical layer Protocol Data Unit (PPDU) in a 2.4 Gigahertz (GHz) band, a 5 GHz band, and a 6 Ghz band.

Example 17 includes the subject matter of Example 15 or 16, and optionally, wherein the 40 MHz operating non-AP STA is capable to support a tone mapping of a 484-tone RU for reception of a 80 MHz HE Multi User (MU) Physical layer Protocol Data Unit (PPDU), an 80+80 MHz HE MU PPDU, and a 160 MHz HE MU PPDU in a 5 Gigahertz (GHz) band, and a 6 Ghz band.

Example 18 includes the subject matter of any one of Examples 15-17, and optionally, wherein the 40 MHz operating non-AP STA is capable to support communication of the data over the RU/MRU allocated to the 40 MHz operating non-AP STA as part of the wider bandwidth HE OFDMA transmission over any one of a 80 MHz channel bandwidth, a 160 MHz channel bandwidth, and an 80+80 MHz channel bandwidth.

Example 19 includes the subject matter of any one of Examples 1-18, and optionally, wherein the apparatus is configured to cause the non-AP STA to transmit to the AP operating channel width information to indicate that the non-AP STA has the 40 MHz operating channel width.

Example 20 includes the subject matter of any one of Examples 1-19, and optionally, wherein the apparatus is configured to cause the non-AP STA to transmit to the AP supported channel width information to indicate that the non-AP STA supports the channel bandwidth of at least 80 MHz.

Example 21 includes the subject matter of any one of Examples 1-20, and optionally, wherein the 40 MHz operating non-AP STA comprises a 40 MHz operating non-AP Extremely High Throughput (EHT) STA.

Example 22 includes the subject matter of any one of Examples 1-21, and optionally, wherein the 40 MHz operating non-AP STA comprises a 40 MHz operating non-AP Ultra High Reliability (UHR) STA.

Example 23 includes the subject matter of any one of Examples 1-22, and optionally, comprising at least one radio to communicate the data over the RU/MRU allocated to the 40 MHz operating non-AP STA.

Example 24 includes the subject matter of Example 23, and optionally, comprising one or more antennas connected to the radio, and a processor to execute instructions of an operating system.

Example 25 includes a wireless communication device including the apparatus of any of Examples 1-24.

Example 26 includes a mobile device including the apparatus of any of Examples 1-24.

Example 27 includes an apparatus including means for executing any of the described operations of any of Examples 1-24.

Example 28 includes a product including one or more tangible computer-readable non-transitory storage media comprising instructions operable to, when executed by at least one processor, enable the at least one processor to cause a wireless communication device to perform any of the described operations of any of Examples 1-24.

Example 29 includes an apparatus including: a memory interface; and processing circuitry configured to: perform any of the described operations of any of Examples 1-24.

Example 30 includes a method including any of the described operations of any of Examples 1-24.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. An apparatus comprising logic and circuitry configured to cause a non Access Point (AP) (non-AP) station (STA) to:
operate in a 40 Megahertz (MHz) operating mode, as a 40 MHz operating non-AP STA, which supports a 40 MHz operating channel width, and which is capable to:
process allocation information from an AP to identify a Resource Unit (RU) or Multiple RU (MRU) (RU/MRU) allocated to the 40 MHz operating non-AP STA within the 40 MHz operating channel width; and
communicate data over the RU/MRU allocated to the 40 MHz operating non-AP STA as part of a wider bandwidth Orthogonal Frequency Division Multiple Access (OFDMA) transmission over a channel bandwidth of at least 80 MHz.

2. The apparatus of claim 1, wherein the 40 MHz operating non-AP STA is capable to transmit a preamble and Uplink (UL) data to the AP over the RU/MRU allocated to the 40 MHz operating non-AP STA as part of a wider bandwidth UL OFDMA transmission over the channel bandwidth of at least 80 MHz.

3. The apparatus of claim 1, wherein the 40 MHz operating non-AP STA is capable to process a received preamble and Downlink (DL) data from the AP over the RU/MRU allocated to the 40 MHz operating non-AP STA as part of a wider bandwidth DL OFDMA transmission over the channel bandwidth of at least 80 MHz.

4. The apparatus of claim 1, wherein the 40 MHz operating non-AP STA is configured to operate in a primary 40 MHz channel of the channel bandwidth of at least 80 MHz.

5. The apparatus of claim 1 configured to allow the 40 MHz operating non-AP STA to operate in a secondary 40 MHz channel of the channel bandwidth of at least 80 MHz, based on a determination that the secondary 40 MHz channel does not include an active 20 MHz subchannel.

6. The apparatus of claim 5 configured to allow the 40 MHz operating non-AP STA to operate in the secondary 40 MHz channel of the channel bandwidth of at least 80 MHz, based on a determination that the non-AP STA supports at least one of a Subchannel Selective Transmission (SST) mode or a dynamic channel operation mode.

7. The apparatus of claim 1, wherein the 40 MHz operating non-AP STA is configured to setup with the AP a Subchannel Selective Transmission (SST) mode by negotiating a trigger-enabled Target Wake Time (TWT) agreement.

8. The apparatus of claim 7, wherein the 40 MHz operating non-AP STA is configured to transmit to the AP a TWT request comprising a TWT channel field having up to 2 bits set to “1” to indicate a requested 40 MHz channel for RU allocations for the 40 MHz operating non-AP STA.

9. The apparatus of claim 8 configured to cause the 40 MHz operating non-AP STA to set a boundary of the requested 40 MHz channel to align with a boundary of an 80 MHz channel in the channel bandwidth of at least 80 MHz.

10. The apparatus of claim 1, wherein the 40 MHz operating non-AP STA is configured to operate in a dynamic channel operation mode over a contiguous 40 MHz channel having a boundary aligned with a boundary of an 80 MHz channel in the channel bandwidth of at least 80 MHz.

11. The apparatus of claim 1, wherein the 40 MHz operating non-AP STA is capable to support communication of the data over the RU/MRU allocated to the 40 MHz operating non-AP STA as part of the wider bandwidth OFDMA transmission over any one of a 80 MHz channel bandwidth, a 160 MHz channel bandwidth, and a 320 MHz channel bandwidth.

12. The apparatus of claim 11, wherein the wider bandwidth OFDMA transmission comprises an Extremely High Throughput (EHT) OFDMA transmission or an Ultra High Reliability (UHR) OFDMA transmission.

13. The apparatus of claim 1, wherein the wider bandwidth OFDMA transmission comprises a High Efficiency (HE) OFDMA transmission.

14. The apparatus of claim 13, wherein the 40 MHz operating non-AP STA is capable to support a tone mapping of a 26-tone RU, a 52-tone RU, a 106-tone RU, a 242-tone RU, and a 484-tone RU for a 40 MHz HE Physical layer Protocol Data Unit (PPDU) in a 2.4 Gigahertz (GHz) band, a 5 GHz band, and a 6 Ghz band.

15. The apparatus of claim 13, wherein the 40 MHz operating non-AP STA is capable to support a tone mapping of a 484-tone RU for reception of a 80 MHz HE Multi User (MU) Physical layer Protocol Data Unit (PPDU), an 80+80 MHz HE MU PPDU, and a 160 MHz HE MU PPDU in a 5 Gigahertz (GHz) band, and a 6 Ghz band.

16. The apparatus of claim 13, wherein the 40 MHz operating non-AP STA is capable to support communication of the data over the RU/MRU allocated to the 40 MHz operating non-AP STA as part of the wider bandwidth HE OFDMA transmission over any one of a 80 MHz channel bandwidth, a 160 MHz channel bandwidth, and an 80+80 MHz channel bandwidth.

17. The apparatus of claim 1 comprising at least one radio to communicate the data over the RU/MRU allocated to the 40 MHz operating non-AP STA.

18. The apparatus of claim 17 comprising one or more antennas connected to the radio, and a processor to execute instructions of an operating system.

19. A product comprising one or more tangible computer-readable non-transitory storage media comprising instructions operable to, when executed by at least one processor, enable the at least one processor to cause a non Access Point (AP) (non-AP) station (STA) to:
operate in a 40 Megahertz (MHz) operating mode, as a 40 MHz operating non-AP STA, which supports a 40 MHz operating channel width, and which is capable to:
process allocation information from an AP to identify a Resource Unit (RU) or Multiple RU (MRU) (RU/MRU) allocated to the 40 MHz operating non-AP STA within the 40 MHz operating channel width; and
communicate data over the RU/MRU allocated to the 40 MHz operating non-AP STA as part of a wider bandwidth Orthogonal Frequency Division Multiple Access (OFDMA) transmission over a channel bandwidth of at least 80 MHz.

20. The product of claim 19, wherein the instructions, when executed, cause the 40 MHz operating non-AP STA to setup with the AP a Subchannel Selective Transmission (SST) mode by negotiating a trigger-enabled Target Wake Time (TWT) agreement.
